(19) United States
(12) Patent Application Publication
(10) Pub. No.: US 2023/0252435 A1
(43) Pub. Date: Aug. 10, 2023

(54) APPARATUS, METHOD, AND COMPUTER PROGRAM PRODUCT FOR MEDIA CONTENT CONSUMPTION TRACKING USING DISTRIBUTED LEDGER

(71) Applicant: Imagine Replay, Inc., Austin, TX (US)

(72) Inventors: Krishna Arvapally, Austin, TX (US); Maduri Arvapally, Austin, TX (US); Daniel Goikhman, Austin, TX (US)

(21) Appl. No.: 18/166,780

(22) Filed: Feb. 9, 2023

Related U.S. Application Data
(60) Provisional application No. 63/308,473, filed on Feb. 9, 2022.

(51) Int. Cl. G06Q 20/10; H04L 67/50; G06Q 40/06

(52) U.S. Cl. CPC G06Q 20/10; H04L 67/535; G06Q 40/06

(57) ABSTRACT

A media content consumption tracking system provides a decentralized, transparent content distribution ecosystem using distributed ledger (e.g., blockchain) technology. The content consumption tracking system receives content request(s) for media content via a content request interface and, for each content request, generates content consumption transaction(s) and records the content consumption transaction(s) on a distributed ledger. Based on the content requests and/or the content consumption transaction(s), the content consumption tracking system causes a content distribution system to deliver the requested content. The content consumption transaction(s) include transfers of token value (e.g., fungible tokens implemented via the distributed ledger) from requesters of the media content to owners, creators, and/or investors associated with the requested media content, from content distribution platforms (e.g., streaming services) to media consumers, and/or tracking data describing, characterizing, and/or quantifying the consumption of the requested media content.

### REFERENCE TO RELATED APPLICATIONS

This application claims priority to and the benefit of U.S. Provisional Application No. 63/308,473, filed Feb. 9, 2022, the entire contents of which are incorporated herein by reference.

### TECHNICAL FIELD

Embodiments of the present disclosure generally relate to digital media content, and specifically, in some examples, to tracking consumption of media content.

### BACKGROUND

Applicant has identified example technical challenges and difficulties associated with current solutions for tracking consumption of media content. Through applied effort, ingenuity, and innovation, Applicant has solved problems relating to tracking consumption of media content.

### BRIEF SUMMARY

According to one aspect, example embodiments of the present disclosure include a method comprising receiving, via a content request interface of a content consumption tracking system, one or more content requests with respect to one or more content data files. Each content data file of the one or more content data files is associated with an owner identifier representing an owner of media content contained within the content data file. Each content request of the one or more content requests comprises a requested content identifier representing a requested content data file of the one or more content data files. The method further comprises, in response to receiving each content request of the one or more content requests, performing operations comprising: generating one or more content consumption transactions based at least in part on the content request; recording the one or more content consumption transactions to the distributed ledger; and causing a content distribution system associated with the content consumption tracking system to distribute the requested content data file represented by the requested content identifier of the content request to a requesting computing device associated with the content request based at least in part on the content request and the one or more content consumption transactions. At least one content consumption transaction of the one or more content consumption transactions represents a transfer of token value to the owner represented by the owner identifier associated with the requested content data file represented by the requested content identifier of the content request, and the token value represents an amount of a medium of exchange native to the content consumption tracking system and implemented via a distributed ledger associated with the content consumption tracking system.

In some embodiments, generating the one or more content consumption transactions for a content request of the one or more content requests comprises generating a content consumption transaction, of the one or more content consumption transactions, representing a transfer of token value from a requesting entity associated with the content request, representing a transfer of token value to a consuming user associated with a content consumer computing device that presents the content contained within the requested content data file to the consuming user, representing a transfer of token value from a consuming user associated with a content consumer computing device that presents the content contained within the requested content data file to the consuming user, and/or including consumption tracking data describing, characterizing, and/or quantifying one or more instances of presenting the content contained within the requested content data file to one or more consuming users. The method may further comprise, in exchange for the transfer of the token value from the consuming user, causing a consumer computing device to present the content contained within the requested content data file without presenting advertising content in conjunction with presentation of the content contained within the requested content data file.

In some embodiments, the method further comprises generating one or more content investment transactions with respect to one or more non-fungible tokens (NFTs) and recording the one or more content investment transactions to the distributed ledger. Each NFT of the one or more NFTs is associated with a content data file of the one or more content data files, and, for each NFT of the one or more NFTs, at least one content investment transaction associated with the NFT represents a transfer of token value from an investing entity to the owner represented by the owner identifier associated with the content data file associated with the NFT in exchange for a transfer of the NFT to the investing entity. Generating the one or more content consumption transactions for a content request of the one or more content requests may comprise determining any investing entities associated with the requested content data file represented by the requested content identifier of the content request based at least in part on the one or more content investment transactions recorded on the distributed ledger and, for each investing entity determined to be associated with the requested content data file, generating a content consumption transaction, of the one or more content consumption transactions, representing a transfer of token value to the investing entity.

In some embodiments, the method further comprises receiving configuration data associated with each content data file of the one or more content data files, generating a content registration transaction associated with each content data file of the one or more content data files based at least in part on the configuration data associated with the content data file, and recording the content registration transaction associated with each content data file of the one or more content data files on the distributed ledger. The configuration data for each content data file of the one or more content data files is received from a computing device associated with the owner represented by the owner identifier associated with the content data file via a content configuration interface of the content consumption tracking system. The one or more content consumption transactions for each content request of the one or more content requests are generated based at least in part on the content registration transaction, of the one or more content registration transactions recorded on the distributed ledger, associated with the requested content data file represented by the requested content identifier of the content request. The content registration transaction associated with each content data file of the one or more content data files may comprise user-specified usage criteria and/or pricing data associated with the content data file.

According to another aspect, embodiments of the present disclosure feature an apparatus comprising at least one processor and at least one non-transitory memory comprising program code stored thereon. The at least one non-transitory memory and the program code are configured to, with the at least one processor, cause the apparatus to at least receive, via a content request interface of a content consumption tracking system, one or more content requests with respect to one or more content data files. Each content data file of the one or more content data files is associated with an owner identifier representing an owner of media content contained within the content data file. Each content request of the one or more content requests comprises a requested content identifier representing a requested content data file of the one or more content data files. The at least one non-transitory memory and the program code are further configured to, with the at least one processor, cause the apparatus to at least, in response to receiving each content request of the one or more content requests, perform operations comprising: generating one or more content consumption transactions based at least in part on the content request; recording the one or more content consumption transactions to the distributed ledger; and causing a content distribution system associated with the content consumption tracking system to distribute the requested content data file represented by the requested content identifier of the content request to a requesting computing device associated with the content request based at least in part on the content request and the one or more content consumption transactions. At least one content consumption transaction of the one or more content consumption transactions represents a transfer of token value to the owner represented by the owner identifier associated with the requested content data file represented by the requested content identifier of the content request, and the token value represents an amount of a medium of exchange native to the content consumption tracking system and implemented via a distributed ledger associated with the content consumption tracking system.

According to another aspect, embodiments of the present disclosure feature a computer program product comprising at least one non-transitory computer-readable storage medium having computer-readable program code portions stored therein. The computer-readable program code portions comprise an executable portion configured to receive, via a content request interface of a content consumption tracking system, one or more content requests with respect to one or more content data files. Each content data file of the one or more content data files is associated with an owner identifier representing an owner of media content contained within the content data file. Each content request of the one or more content requests comprises a requested content identifier representing a requested content data file of the one or more content data files. The computer-readable program code portions further comprise an executable portion configured to, in response to receiving each content request of the one or more content requests, perform operations comprising: generating one or more content consumption transactions based at least in part on the content request; recording the one or more content consumption transactions to the distributed ledger; and causing a content distribution system associated with the content consumption tracking system to distribute the requested content data file represented by the requested content identifier of the content request to a requesting computing device associated with the content request based at least in part on the content request and the one or more content consumption transactions. At least one content consumption transaction of the one or more content consumption transactions represents a transfer of token value to the owner represented by the owner identifier associated with the requested content data file represented by the requested content identifier of the content request, and the token value represents an amount of a medium of exchange native to the content consumption tracking system and implemented via a distributed ledger associated with the content consumption tracking system.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an exemplary content consumption tracking system, in accordance with at least some example embodiments of the present disclosure;

FIG. 4 is a flowchart depicting an example process for receiving and registering content data files containing media content, in accordance with at least some example embodiments of the present disclosure;

FIG. 5 is a flowchart depicting an example process for generating and recording content investment transactions, in accordance with at least some example embodiments of the present disclosure;

FIG. 6 is a flowchart depicting an example process for tracking media content consumption using a distributed ledger, in accordance with at least some example embodiments of the present disclosure; and

FIG. 7 is a flowchart depicting an example process for generating content consumption transactions transferring token value to investing entities associated with requested media content, in accordance with at least some example embodiments of the present disclosure.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

As internet availability, access, and quality expands, digital content is widely and increasingly consumed by users. Such digital content includes video, audio, images, and text, to list a few examples. Subscription-based streaming video platforms have emerged as particularly popular providers of video content such as movies or television shows. Some platforms allow individual content creators to upload user-generated video content, which is then widely distributed as on-demand or live video streams. Audio content platforms have also emerged for providing streaming or locally downloaded audio content such as music or podcasts. Often, owners and/or creators of digital content will license or otherwise distribute their work (e.g., via subscription- and/or ad-based platforms) in exchange for compensation. Various methods of compensating owners and/or creators of digital content have emerged.

However, the techniques used in compensating owners and/or creators of digital content have a number of problems. Often, such methods involve opaque revenue sharing arrangements that are based on proprietary formulas and unreliable tracking methods for distributing revenue shares. These proprietary formulas lack transparencies and often include fees that diminish the amount of revenue share paid to content owners/creators. Only a relatively small proportion of content distribution platforms allow self-uploading of content, with a much larger proportion operating based on traditional deal-making between the platforms and content owners, often with several middlemen such as agents or brokers. Deals resulting from this process often vary significantly based on the distribution endpoint. Moreover, many content distribution platforms are large enough to dictate distribution terms (e.g., pricing models) that are often unsustainable for content creators/owners. Larger content distribution platforms might even impose preferred vendor arrangements for various aspects of content distribution and delivery, resulting in content creators/owners having to deal with different vendors for each platform, and a lack of standard specifications for these various aspects of content distribution and delivery makes this task especially complex, time-consuming, and challenging, especially for smaller scale (e.g., individual) content creators/owners. Many compensation arrangements rely on tracking of content consumption (e.g., for payments that are proportional to usage of the content in question), but the tracking often lacks transparency and uniformity across different platforms and often lags behind content consumption significantly, with payments not reaching content creators/owners until months, quarters, or even years after the content was consumed. As a result, content creators/owners are often not compensated fairly for their work and are deprived of timely proceeds that could be reinvested into further content production.

The presently disclosed media content consumption tracking system solves at least the above discussed problems by providing a decentralized, transparent content distribution ecosystem using distributed ledger (e.g., blockchain) technology. The content consumption tracking system allows content creators/owners to make their media content available to many distribution platforms and publishers (and thus to a maximally wide audience of consumers), provides accurate and timely tracking and measurement of consumption of such media content, and determines and provides compensation in real time based on such tracking and measurement.

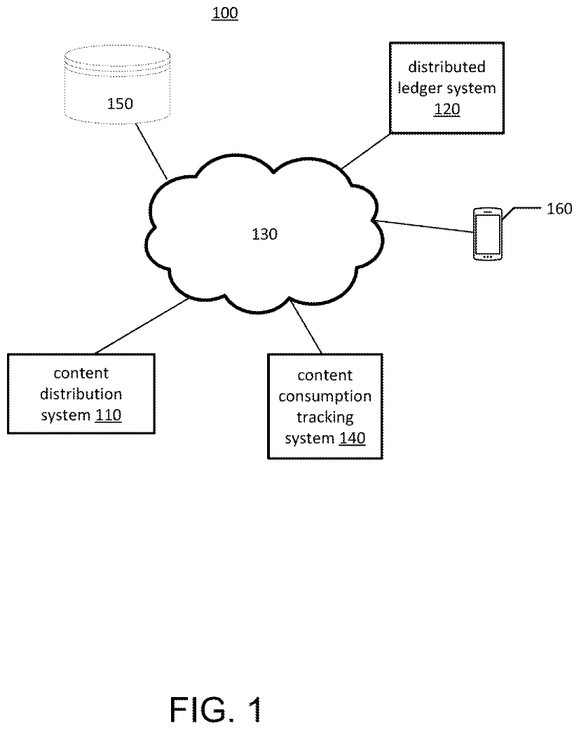

FIG. 1 illustrates an exemplary block diagram of an environment 100 in which embodiments of the present disclosure may operate. Specifically, FIG. 1 illustrates a content consumption tracking system 140, a content distribution system 110, a distributed ledger system 120, one or more data repositories 150, and one or more user devices 160, all connected to a network 130.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The one or more data repositories 150 may be configured to receive, store, and/or transmit data. In some embodiments, the one or more data repositories 150 store content data containing media content to be distributed to user devices 160 associated with consumers of the media content. The content data may be stored by the one or more data repositories in the form of one or more content data files.

The distributed ledger system 120 may be a computing system or device (e.g., server system), or combination of multiple such systems or devices, configured via hardware, software, firmware, and/or a combination thereof, to implement a distributed ledger. In some embodiments, the distributed ledger may be a decentralized storage system in which multiple instances of the same data are stored as local ledger copies on nodes of a peer to peer network. The distributed ledger may comprise a series of transactions, which may be validated by the nodes, for example, to confirm that the transactions are compatible with the transaction history indicated by the local ledger copy of each node. Validated transactions may be propagated across the peer to peer network as new ledger entries, and the local ledger copies may be synchronized according to consensus algorithms that determine an authoritative version of the ledger based on consensus criteria, which may include which nodes were first to solve a cryptographic puzzle, a chance selection weighted such that nodes representing entities with more ownership stake in the ledger have a higher chance of selection, and/or voting systems, to list a few examples. The distributed ledger implemented by the distributed ledger system 120 may be a blockchain, in which transactions are organized into blocks, which are then validated and propagated across the peer to peer network. Each block of the blockchain may contain a cryptographic hash of the full contents of the previous block, forming chains of linked blocks that can be traced back to an original block of the blockchain. In various embodiments, the distributed ledger implemented by the distributed ledger system 120 may prevent alteration of any blocks of the blockchain by virtue of any attempts to alter contents of a block being easily detectable by necessitating commensurate changes to the cryptographic hashes contained in every subsequent block in order for the altered portion of the blockchain to be considered valid by the distributed ledger system 120.

The content distribution system 110 may be a computing system or device (e.g., server system), or combination of multiple such systems or devices, configured via hardware, software, firmware, and/or a combination thereof, to distribute to and/or present on user devices 160 the media content contained in the content data stored by the one or more data repositories 150. The content distribution system 110 may be or may comprise a content delivery network, which may comprise a spatially distributed network of servers and/or data centers for transmitting the content data to user devices 160 across a wide geographic area. In some embodiments, the content distribution system 110 may be a hybrid system that uses a decentralized, peer-to-peer data delivery network in conjunction with a traditional content delivery network. The content distribution system 110 may be associated with and/or may utilize a distributed ledger (e.g., implemented via the distributed ledger system 120), for example, to incentivize contributions to the peer-to-peer network by various peer nodes, which might, for example, locally cache portions of the media content and provide access to the cached media content to other peer nodes. In one example, in exchange for media content caching and/or other contributions, the content distribution system 110 may cause compensation to be paid to entities associated with the peer nodes by generating and recording on the distributed ledger transactions transferring an amount of a medium of exchange (e.g., digital currency, cryptocurrency, fungible token value) based on the peer node's contributions. In some embodiments, the distributed ledger utilized by the content distribution system 110 may be the same distributed ledger utilized by the content consumption tracking system 140. In some embodiments, the content consumption tracking system 140 may communicate with the content distribution system 110 via a distributed ledger (e.g., by recording transactions to the distributed ledger intended to be detected and/or retrieved by the other system and retrieving transactions from the distributed ledger recorded by the other system, by interacting with smart contracts recorded on the distributed ledger).

The one or more user devices 160 may be associated with users, including consumers of the media content, creators and/or owners of the media content, and/or investors associated with the media content.

The content consumption tracking system 140 may be a computing system or device (e.g., server system), or combination of multiple such systems or devices, configured via hardware, software, firmware, and/or a combination thereof, to receive and store content data (e.g., uploaded from user devices 160) containing media content, generate and record on the distributed ledger of the distributed ledger system 120 various types of transactions with respect to the media content, and to provide access by the user devices 160 to the media content (e.g., based on transactions recorded in the distributed ledger system). For example, in various embodiments, the content consumption tracking system 140 and/or the content distribution system 110 may cause content data containing the media content to be transmitted to and/or presented (e.g., displayed, played through speakers) on user device(s) 160 associated with consumers of the media content. In another example, in some embodiments, the content consumption tracking system 140 may cause data and/or interfaces associated with requesting the media content to be transmitted to and/or presented on user device(s) 160 associated with the consumers of the media content. In yet another example, in some embodiments, the content consumption tracking system 140 may cause data and/or interfaces associated with uploading, registration, and/or configuration of content data containing the media content to be transmitted to and/or presented on user device(s) 160 associated with owners and/or creators of the media content. In yet another example, in some embodiments, the content consumption tracking system 140 may cause data and/or interfaces associated with investing in the media content to be transmitted to and/or presented on user device(s) 160 associated with investors in the media content. Based at least in part on data received via the various interfaces presented by the content consumption tracking system 140, the system may generate and record on the distributed ledger of the distributed ledger system 120 transactions, which may then determine how and/or whether subsequent transactions are generated and/or how and/or whether requested media content is presented on the user devices 160.

While FIG. 1 illustrates certain components as separate, standalone entities communicating over the network 130, various embodiments are not limited to this configuration. In other embodiments, one or more components may be directly connected and/or share hardware or the like.

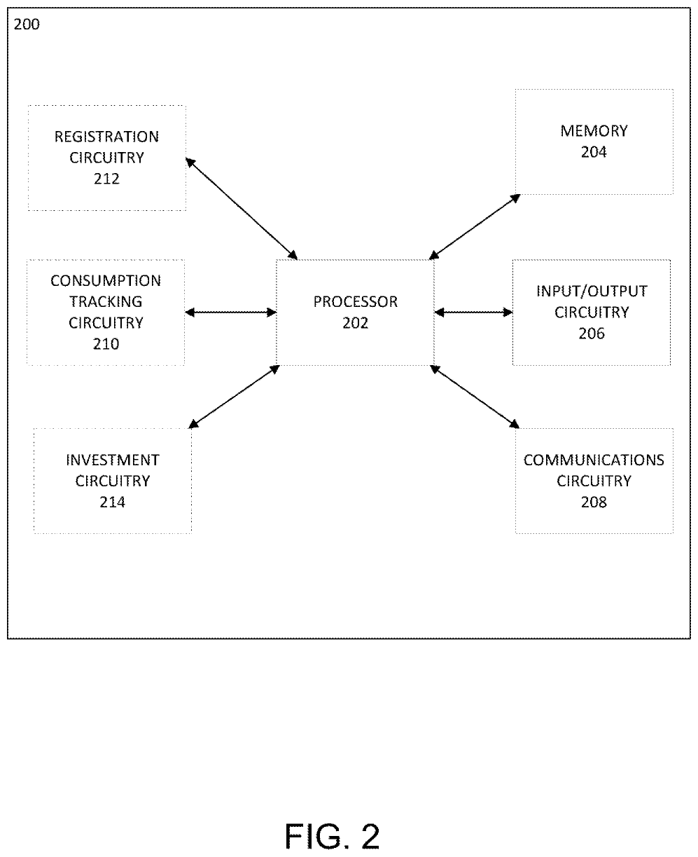

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, a content distribution system 110, a distributed ledger system 120, a content consumption tracking system 140, data repositories 150, and/or user devices 160. The apparatus 200 includes processor 202, memory 204, input/output circuitry 206, communications circuitry 208, and/or optional consumption tracking circuitry 210, registration circuitry 212, and/or investment circuitry 214. In some embodiments, the apparatus 200 is configured to execute and perform the operations described herein.

Although components are described with respect to certain functional roles, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, a device, system, or apparatus, such as apparatus 200 of a content distribution system 110, a distributed ledger system 120, a content consumption tracking system 140, data repositories 150, and/or user devices 160, may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry embodying the memory 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Consumption tracking circuitry 210 may be included in the apparatus 200. The consumption tracking circuitry 210 may include hardware, software, firmware, and/or a combination thereof, designed and/or configured to perform one or more operations described herein concerning receiving and processing, content requests, generating and recording on the distributed ledger content consumption transactions, and/or cause distribution of requested content to user devices 160 (e.g., via the content distribution system 110).

Registration circuitry 212 may be included in the apparatus 200. The registration circuitry 212 may include hardware, software, firmware, and/or a combination thereof, designed and/or configured to perform one or more operations described herein concerning receiving and storing content data, receiving configuration data associated with the content data, and/or generating and recording on the distributed ledger registration transactions with respect to the content data.

Investment circuitry 214 may be included in the apparatus 200. The investment circuitry 214 may include hardware, software, firmware, and/or a combination thereof, designed and/or configured to perform one or more operations described herein concerning receiving investment requests and/or generating and recording on the distributed ledger investment transactions based on the investment requests.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the consumption tracking circuitry 210, may be combined with the processor 202, such that the processor 202 performs one or more of the operations described herein with respect to the consumption tracking circuitry 210.

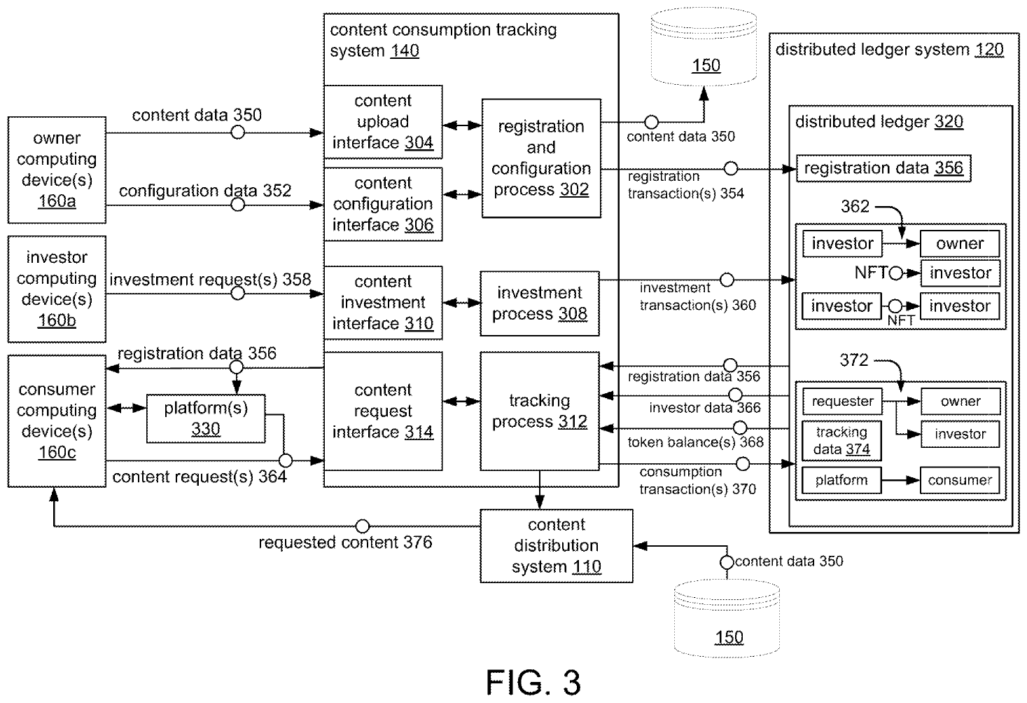

FIG. 3 is an illustration of a content consumption tracking system 140, in accordance with at least some example embodiments of the present disclosure. Specifically, FIG. 3 includes schematic depictions of the content consumption tracking system 140, distributed ledger system, user devices 160, content distribution system 110, and the one or more data repositories 150, schematic depictions of example internal processes, subsystems, and components of the content consumption tracking system 140 along with example data objects used by and/or produced by the example systems, internal processes, subsystems, and/or components. The content consumption tracking system 140, internal processes, subsystems, and/or components thereof, and/or apparatuses 200 associated therewith, for example, may be specially configured via hardware, software, firmware, and/or a combination thereof, to perform the various data processing and interactions described with respect to FIG. 3 to provide tracking of media content consumption.

In the illustrated example, the content consumption tracking system 140 comprises a registration and configuration process 302 in communication with a content upload interface 304 and a content configuration interface 306, an investment process 308 in communication with a content investment interface 310, and a tracking process 312 in communication with a content request interface 314.

The registration and configuration process 302 may be configured to perform and/or facilitate initial receipt and configuration of (e.g., newly uploaded) media content from owner computing devices 160a (e.g., of the one or more computing devices 160) and registration of the media content on a distributed ledger 320 of the distributed ledger system 120.

The owner computing devices 160a may be associated with creators and/or owners of the media content.

In various embodiments, the registration and configuration process 302 may be configured to present the content upload interface 304 for receiving content data 350 containing the media content. For example, the registration and configuration process 302 may be configured to present the content upload interface within a graphical user interface (GUI) rendered on one or more displays of the owner computing devices 160a, in which case, the content upload interface 304 may comprise interactable elements (e.g., selectable graphical elements, data input elements) for detecting user input indicative of a selection of content data 350 (e.g., one or more content data files) locally stored by and/or accessible to the owner computing devices 160a. The content upload interface 304, in conjunction with the owner computing devices 160a, may cause transmission of the selected content data 350 to the content consumption tracking system 140, for example, by the owner computing devices 160a and/or by a server device in communication with and/or otherwise associated with the owner computing devices 160a. In another example, the registration and configuration process 302 may be configured to present the content upload interface by exposing an application programming interface (API) configured to receive the content data 350.

The registration and configuration process 302 may be configured to store the content data 350 received from the owner computing devices 160a via the content upload interface 304 in the one or more data repositories 150, which may be associated with the content consumption tracking system 140 and/or the content distribution system 110. In some embodiments, the registration and configuration process 302 may be configured to perform one or more conversion and/or transcoding processes with respect to the content data 350 and to store the processed content data 350. Each content data file or set of content data files (of the content data 350) pertaining to a particular discrete unit of media content may be associated with an owner identifier representing an owner and/or creator of the particular discrete unit of media content contained within the content data file(s). Moreover, each content data file or set of content data files (of the content data 350) pertaining to a particular discrete unit of media content may be associated with a content identifier representing the content data file or set of content data files and/or the particular discrete unit of media content. The owner identifier(s) and/or content identifier(s) associated with the content data 350 may be stored as part of the content data 350 and/or metadata thereof in the one or more data repositories 150.

In various embodiments, the registration and configuration process 302 may be configured to present the content configuration interface 306 for receiving configuration data 352 associated with the received content data 350. For example, the registration and configuration process 302 may be configured to present the content configuration interface 306 within a GUI rendered on one or more displays of the owner computing devices 160a, in which case, the content configuration interface 306 may comprise interactable elements (e.g., selectable graphical elements, data input elements) for detecting user input indicative of the configuration data 352. The content configuration interface 306, in conjunction with the owner computing devices 160a, may cause transmission of the configuration data 352 indicated in the detected user input to the content consumption tracking system 140, for example, by the owner computing devices 160a. In another example, the registration and configuration process 302 may be configured to present the content configuration interface 306 by exposing an API configured to receive the configuration data 352.

The configuration data 352 may comprise any metadata associated with and/or describing the content data 350. More particularly, the configuration data 352 may define customized, user-specified distribution and/or licensing specifications and/or criteria associated with the content data 350, including usage criteria (e.g., specifying licensing conditions for distributing and/or using the media content to be enforced by the content consumption tracking system 140 and/or content distribution system 110) and/or pricing data (e.g., specifying one or more prices representing values of a medium exchange to be transferred to the owner and/or creator in exchange for accessing, distributing, using, and/or consuming the media content).

In various embodiments, the registration and configuration process 302 may be configured to generate one or more registration transactions 354 associated with the received content data 350 based at least in part on the received configuration data 352 and/or the content data 350 and to record the registration transaction(s) 354 on the distributed ledger 320.

The registration transactions 354 recorded on the distributed ledger 320 may comprise or form registration data 356 associated with and/or descriptive of each discrete unit (e.g., work, production, show, movie, episode) of media content contained in the content data 350, which registration data 356 may be used to provide a catalog of media content available for licensing, use, distribution, and/or consumption upon request (e.g., by consumers and/or distributors of the media content) and/or to provide data used by the content consumption tracking system 140 in processing any requests for the media content. For example, the registration data 356 may comprise a content identifier associated with and/or representing a particular set of content data 350 (e.g., a particular content data file or set of content data files) that constitutes the discrete unit of media content to which the registration data 356 is associated. The registration data 356 may comprise media content metadata descriptive of the discrete unit of media content to which the registration data 356 is associated (e.g., title, creator(s), duration, type, format, description, episode number, publication date, category, language). The registration data 356 may comprise owner and/or creator data such as an owner identifier representing and/or associated with an entity that owns and/or that created the discrete unit of media content to which the registration data 356 is associated. The registration data 356 may comprise technical data for distributing the discrete unit of media content to which the registration data 356 is associated, such as addresses and/or identifiers representing and/or associated with one or more streams and/or feeds (e.g., media resource description framework (MRSS) feeds) or locations thereof that can be used to access and/or present the content data 350 containing the discrete unit of media content to which the registration data 356 is associated. The registration data 356 may comprise some or all of the configuration data 352, including usage criteria and/or pricing data associated with licensing, use, distribution, and/or consumption of the media content, identification of creators and/or owners of the media content.

The investment process 308 may be configured to facilitate and/or generate investments with respect to investing entities and individual discrete units of media content or groups thereof. The investment may concern portions of revenue streams associated with and/or generated from the media content that can be designated as payable to the investing entities holding the investment. For example, the content consumption tracking system 140 may designate an investing entity as entitled to a portion of the revenue stream associated with a unit of media content in exchange for a transfer of an investment value representing an amount of a medium of exchange from the investing entity to the owner of the media content. The extent of the portion of the revenue stream may be predetermined or may be proportionate to the investment value, for example. In this way, the content consumption tracking system 140 may allow content creators and/or owners to generate revenue with respect to a unit of media content at a relatively early stage (e.g., before distribution of the media content) while allowing investing entities to promote creation of and/or share in the success of media content in which they are invested. In some embodiments, the investment process 308 may be configured to facilitate and/or generate such investments by communicating with investor computing devices 160b (e.g., of the one or more computing devices 160) and generating and recording transactions on the distributed ledger 320.

The investor computing devices 160b may be associated with the investing entities.

In various embodiments, the investment process 308 may be configured to present the content investment interface 310 for receiving investment requests 358 from the investor computing devices 160b. For example, the investment process 308 may be configured to present the content investment interface 310 within a GUI rendered on one or more displays of the investor computing devices 160b, in which case, the content investment interface 310 may comprise interactable elements (e.g., selectable graphical elements, data input elements) for detecting user input indicative of selected parameters and/or criteria for a requested investment (e.g., a selected unit of media content to invest in from a set of units of media content available for investment, a selected or user-input investment value corresponding to the requested investment). The content investment interface 310, in conjunction with the investor computing devices 160b, may cause transmission of the investment requests 358 to the content consumption tracking system 140, for example, by the investor computing devices 160b. In another example, the investment process 310 may be configured to present the content investment interface 310 by exposing an API configured to receive the investment requests 358.

The investment process 308 may be configured to generate one or more investment transactions 360 based at least in part on the investment requests 358 received via the content investment interface 310 and/or based on any other relevant data and to record the investment transactions 360 on the distributed ledger 320.

The investment transactions 360 for a particular investment may comprise one or more token transfers 362 defining, establishing, modifying, and/or otherwise associated with transfers of token value and/or non-fungible tokens (NFTs) from and/or to particular parties in connection with the particular investment.

In some embodiments, the investment process 308 may be configured to generate the investment transaction(s) 360 with respect to one or more NFTs. Each NFT of the one or more NFT may be associated with one or more content data files (e.g., of the content data 350) and/or a discrete unit of media content contained in the content data file(s). For each NFT of the one or more NFTs, the investment process 308 may generate at least one content investment transaction associated with the NFT representing a transfer of token value from an investing entity to the owner and/or creator associated with the content data file(s) associated with the NFT in exchange for a transfer of the NFT to the investing entity.

The token value may represent an amount of a medium of exchange native to the content consumption tracking system 140 and/or implemented via the distributed ledger 320. For example, the token value may represent an amount of a fungible token defined via one or more transactions recorded on the distributed ledger 320 according to one or more predefined fungible token protocols (e.g., ERC20 standard associated with the Ethereum blockchain, TNT-20 token standard associated with the Theta blockchain).

The NFTs may represent and/or signify ownership of a particular digital asset (e.g., investments in media content) and/or entitlement to all or a portion of revenue derived therefrom and may comprise a unique digital identifier associated with the particular digital asset. Transactions may be recorded to the distributed ledger 320 that establish an NFT and/or transfer ownership of an NFT from and/or to an individual.

In one example, the token transfers 362 included in the investment transactions 360 recorded on the distributed ledger 320 may represent a transfer of (e.g., fungible) token value from an investing entity to an owner and/or creator of media content associated with the investment (e.g., corresponding to an initial investment by the investing entity with respect to the media content).

In another example, the token transfers 362 included in the investment transactions 360 recorded on the distributed ledger 320 may represent definition and/or establishment of an NFT representing an investment with respect to the media content. The investment transactions 360 may represent transfer of the defined and/or established NFT to an investing entity (e.g., in exchange for an initial investment by the investing entity with respect to the media content).

In yet another example, the token transfers 362 included in the investment transactions 360 recorded on the distributed ledger 320 may represent a transfer of an NFT representing an investment with respect to the media content from a first investing entity to a second investing entity.

The tracking process 312 may be configured to track consumption of the media content by processing requests from consumer computing devices 160c (e.g., of the one or more computing devices 160) and recording transactions on the distributed ledger 320 based on the requests. Additionally or alternatively, in some embodiments, the tracking process 312 may be configured to track consumption of the media content by processing requests from one or more content distribution platforms 330 (e.g., video streaming platforms, podcast streaming and/or downloading platforms), which platforms 330 may be interposed between the consumer computing devices 160c and the content consumption tracking system 140. The platforms 330 may request the media content on behalf of the consumers based on interactions with the consumer computing devices 160c, for example.

The consumer computing devices 160c may be associated with the consumers (e.g., viewers, listeners) of the media content.

In various embodiments, the tracking process 312 may be configured to present the content request interface 314 for receiving content requests 364. For example, the tracking process 312 may be configured to present the content request interface 314 within a GUI rendered on one or more displays of the consumer computing devices 160c, in which case, the content request interface 314 may comprise interactable elements (e.g., selectable graphical elements, data input elements) for detecting user input indicative of a selection of requested media content. The content request interface 314, in conjunction with the consumer computing devices 160c, may cause transmission of the content request 364 to the content consumption tracking system 140, for example, by the consumer computing devices 160c and/or by a server device in communication with and/or otherwise associated with the consumer computing devices 160c. In another example, the tracking process 312 may be configured to present the content request interface 314 by exposing an API configured to receive the content requests 364 from the consumer computing devices 160c and/or the content distribution platform(s) 330.

The tracking process 312 presenting the content request interface 314 may comprise retrieving data from the transactions recorded on the distributed ledger 320 and presenting the retrieved data as part of the content request interface 314. For example, the tracking process 312 may be configured to retrieve registration data 356 (e.g., from the registration transactions 354 recorded on the distributed ledger 320) and present some or all of the retrieved registration data 356 as part of the content request interface 314, including any metadata descriptive of the discrete unit of media content to which the registration data 356 is associated (e.g., title, creator(s), duration, type, format, description, episode number, publication date, category, language), usage criteria, and/or pricing data associated with licensing, use, distribution, and/or consumption of the media content. Thus, for example, the content request interface 314 may provide a selectable catalog of media content that can be requested by the consumer computing devices 160c and/or the content distribution platform(s) 330, including identifying information about the units of media content (e.g., discrete works) available for request and costs and/or conditions associated with requesting each unit of media content.

The tracking process 312, via the content request interface 314, may be configured to receive the content requests 364 with respect to one or more content data files of the content data 350 stored in the one or more data repositories 150 and/or, for example, with respect to one or more discrete units of media content contained within the one or more content data files. For example, each content request 364 may comprise a requested content identifier representing a requested content data file or set of content data files and/or, for example, a discrete units of media content contained within the content data file(s). In one example, the requested content identifier of the content request 364 may correspond to, may refer to, and/or may map to the content identifier(s) provided as part of the metadata of the content data 350 and/or as part of the registration data 356 provided in the registration transactions 354 recorded on the distributed ledger 320.

In various embodiments, the tracking process 312 may be configured to generate one or more content consumption transactions 370 based at least in part on the content requests 364 received via the content request interface 314. More particularly, the tracking process 312 may be configured to generate one or more content consumption transactions 370 for each particular content request 364 in response to receiving the particular content request 364 and based at least in part on the particular content request 364. The tracking process 312 may be configured to record the consumption transactions 370 on the distributed ledger 320.

The consumption transactions 370 associated with a particular content request 364 may comprise one or more token transfers 372 defining, establishing, modifying, and/or otherwise associated with transfers of token value from and/or to particular parties in connection with the particular content request 364.

As before, the token value associated with the consumption transactions 370 may represent an amount of a medium of exchange native to the content consumption tracking system 140 and/or implemented via the distributed ledger 320. For example, the token value may represent an amount of a fungible token defined via one or more transactions recorded on the distributed ledger 320 according to one or more predefined fungible token protocols (e.g., ERC20 standard associated with the Ethereum blockchain, TNT-20 token standard associated with the Theta blockchain).

In one example, the token transfers 372 included in the consumption transactions 370 generated by the tracking process 312 and recorded on the distributed ledger 320 may represent a transfer of (e.g., fungible) token value from a requesting entity (e.g., a content consumer associated with the consumer computing device 160c that transmitted the content request 364, a content distribution entity associated with the content distribution platform 330 that transmitted the content request 364) to an owner and/or creator of the requested media content indicated in the content request 364. Additionally, the token transfers 372 may represent a transfer of the token value from the requesting entity to an investing entity associated with the requested media content indicated in the content request 364 (e.g., via the investment transactions 360 recorded on the distributed ledger 320).

In another example, the token transfers 372 included in the consumption transactions 370 generated by the tracking process 312 and recorded on the distributed ledger 320 may represent a transfer of (e.g., fungible) token value from a content distribution entity (e.g., associated with the content distribution platform 330) to a content consumer (e.g., associated with the consumer computing device 160c on which the media content is presented). Thus, for example, the content consumption tracking system 140 may enable compensation schemes other than or in addition to compensation of owners and/or investors associated with the media content, such as compensation of consumers for consuming the media content (which may be advertisement-supported and presented in conjunction with sponsored content such as advertisements).

In yet another example, the consumption transactions 370 generated by the tracking process 312 and recorded on the distributed ledger 320 may contain tracking data 374 associated with the content data 350 and/or the requesting entities (e.g., content consumers, content distribution entities associated with the content distribution platforms 330). The tracking data 374 may comprise data that identifies content data 350, content data file(s), and/or discrete units of media content (e.g., requested in the content requests 364), data that identifies one or more requesting entities associated with a content request 364 (e.g., content consumers, consumer computing devices 160c, content distribution entities, content distribution platforms 330), data that describes, characterizes, and/or quantifies the media content consumption resulting from the content requests 364 (e.g., duration of media consumption session, proportions of requested media content that was actually presented and/or consumed, token values transferred in connection with the content requests 364), and/or any other data relevant to the content requests 364 and accessible to the content consumption tracking system 140. The tracking data 374 may be included as part of the token transfers 372 included in the consumption transactions 370 (e.g., indicated in a data field associated with the token transfers 372) and/or as part of designated consumption transactions 370 that do not represent token transfers 372.

In various embodiments, the tracking process 312 may be configured to, for each particular content request 364, in response to receiving the particular content request 364, and based at least in part on the particular content request 364, cause the content distribution system 110 to distribute the content data file(s) of the content data 350 corresponding to the requested content 376 to a requesting computing device associated with the content request 364, such as a consumer computing device 160c and/or a device or server of the content distribution platform 330. In some embodiments, the tracking process 312 may be configured to cause the content distribution system 110 to distribute the requested content 376 by communicating with the content distribution system 110, for example, over the network 130 and/or via transactions (e.g., consumption transactions 370) generated by the tracking process 312 and recorded on one or more distributed ledgers associated with the content distribution system 110, including possibly the distributed ledger 320. The tracking process 312 may be configured to cause the content distribution system 110 to distribute the requested content 376 based at least in part on the consumption transaction(s) 370 generated by the tracking process 312 and recorded on the distributed ledger 320. For example, the tracking process 312 may be configured to determine whether a requesting party (e.g., media consumer associated with a consumer computing device 160c, media distribution entity associated with media distribution platform 330) has a sufficiently high token balance such that a token value representing an amount corresponding to a price associated with the requested media content (e.g., in the pricing data provided in the registration data 356) can be successfully transferred to the owner, creator, and/or investor(s) associated with the requested media content and to cause the content distribution system 110 to distribute the requested content 376 only in response to determining that the token balance is sufficiently high. In another example, the tracking process 312 may be configured to communicate technical details (e.g., identifiers and/or addresses associated with content streams and/or feeds corresponding to the requested media content) included in the registration data 356 to the content distribution system 110 and/or to communicate with the content distribution system 110 based at least in part on the technical details.

The tracking process 312 generating the consumption transaction(s) 370 and/or causing the content distribution system 110 to distribute the requested content 376 may comprise retrieving data from the transactions recorded on the distributed ledger 320 and using the retrieved data to determine which consumption transactions 370 to generate, to determine any attributes of the transactions 370, and/or to determine how the content distribution system 110 is caused to distribute the requested content 376.

More particularly, in some embodiments, the tracking process 312 may be configured to retrieve registration data 356 (e.g., from the registration transactions 354 recorded on the distributed ledger 320) and generate consumption transactions 370 including token transfers 372 based at least in part on the retrieved registration data 356. In one example, the tracking process 312 may be configured to determine a recipient of a token transfer 372 associated with a content request 364 based at least in part on an owner identifier indicated in the registration data 356 corresponding to the requested content 376. In another example, the tracking process may be configured to determine an amount of a token transfer 372 associated with a content request 364 based at least in part on the pricing data indicated in the registration data 356 corresponding to the requested content 376. In another example, the tracking process 312 may be configured to determine whether or not to allow distribution of the requested content 376 based at least in part on the usage criteria indicated in the registration data 356 corresponding to the requested content 376.

In some embodiments, the tracking process 312 may be configured to retrieve investor data 366 (e.g., from the investment transactions 360 recorded on the distributed ledger 320) and generate consumption transactions 370 including token transfers 372 based at least in part on the retrieved investor data 366. The investor data 366 may identify one or more investing entities currently associated with the requested media content, which may be determined based at least in part on the investment transactions 360 (e.g., current owners of NFTs representing investments with respect to the requested content 376). The tracking process 312 may be configured to determine a recipient of a token transfer 372 associated with a content request 364 based at least in part on the one or more investing entities determined to be currently associated with the requested media content. The tracking process may be configured to determine an amount of a token transfer 372 associated with a content request 364 based at least in part on the characteristics and/or quantities of NFTs owned by the one or more investing entities determined to be currently associated with the requested media content according to the investment transactions 360.

In some embodiments, the tracking process 312 may be configured to retrieve token balances 368 associated with various entities for which token transfers 372 are to be recorded (e.g., from the consumption transactions 370 recorded on the distributed ledger 320) and generate consumption transactions 370 including token transfers 372 based at least in part on the retrieved registration data 356. In one example, the tracking process 312 may be configured to determine whether a requesting party (e.g., media consumer associated with a consumer computing device 160c, media distribution entity associated with media distribution platform 330) has a sufficiently high token balance such that a token value representing an amount corresponding to a price associated with the requested media content (e.g., in the pricing data provided in the registration data 356) can be successfully transferred to the owner, creator, and/or investor(s) associated with the requested media content and to generate the consumption transaction(s) 370 with the token transfer(s) 372 only in response to determining that the token balance is sufficiently high.

The token balance(s) 368 may also be used by the tracking process 312 to determine how and/or whether to cause the content distribution system 110 to distribute the requested content 376, according to the examples previously described. In another example, the tracking process 312 may use the token balance(s) 368 to determine whether the requested content 376 should be presented with or without additional sponsored advertising content. Based at least in part on the token balance(s) 368, the tracking process 312 may generate content consumption transaction(s) 370 representing a transfer of token value from a media consumer (e.g., associated with the consumer computing device 160c that requested and/or that will present the requested content 376) and, in exchange for that token transfer, cause the consumer computing device 160c (e.g., via the content distribution system 110 and/or the content distribution platform(s) 330) to present the requested content 376 without presenting additional advertising content in conjunction with the presentation of the requested content 376. In response to determining that the media consumer does not have a sufficient token balance (from the token balance(s) 368 retrieved from the distributed ledger 320) to cover the transfer, the tracking process 312 may cause the consumer computing device 160c (e.g., via the content distribution system 110 and/or the content distribution platform(s) 330) to present the additional advertising content in conjunction with the presentation of the requested content 376.

In some embodiments, some or all of the functionality of the registration and configuration process 302, investment process 308, and/or the tracking process 312 may be embodied in smart contracts recorded on the distributed ledger 320. The smart contracts may comprise instructions (e.g., for performing the functionality of and/or corresponding to the functionality of the respective processes), and the distributed ledger system 120 may be configured to automatically execute or automatically cause execution (e.g., by peer nodes) of the instructions in response to calls to and/or interactions with the recorded smart contracts. In one example, the content request interface 314 may be embodied in a smart contract recorded on the distributed ledger 320, and the content requests 364 may be embodied in transactions recorded on the distributed ledger 320 that reference the smart contract, including data such as that discussed above in connection with the content requests 364 provided in a data field of the transactions and/or token transfers from the requesting entities (e.g., media consumer associated with a consumer computing device 160c, media distribution entity associated with media distribution platform 330) to an account associated with the smart contract. In response to recordation of such a transactions referencing the smart contract, the distributed ledger system 120 may be configured to cause execution of the instructions provided in the smart contract, which instructions may correspond to some or all of the functionality attributed herein to the tracking process 312. The content investment interface 310 may be embodied in a smart contract in a similar manner, in another example.

In some embodiments, the content consumption tracking system 140 may comprise a software development kit (SDK) configured to enable and/or facilitate communication and/or interactions between, for example, software processes of the content distribution platform(s) 330, the content consumption tracking system 140, and/or the distributed ledger 320.

Having described example systems and/or apparatuses of the present disclosure, example flowcharts including various operations performed by the apparatuses and/or systems described herein will now be discussed. It should be appreciated that each of the flowcharts depicts an example computer-implemented process that may be performed by one or more of the apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur in-between one or more blocks of another process, before one or more blocks of another process, and/or otherwise operates as a sun-process of a second process. Additionally or alternatively, any of the processes may include some or all of the steps described and/or depicted, including one or more optional operational blocks in some embodiments. With respect to the flowcharts discussed below, one or more of the depicted blocks may be optional in some, or all, embodiments of the disclosure. Similarly, it should be appreciated that one or more of the operations of each flowchart may be combinable, replaceable, and/or otherwise altered as described herein.

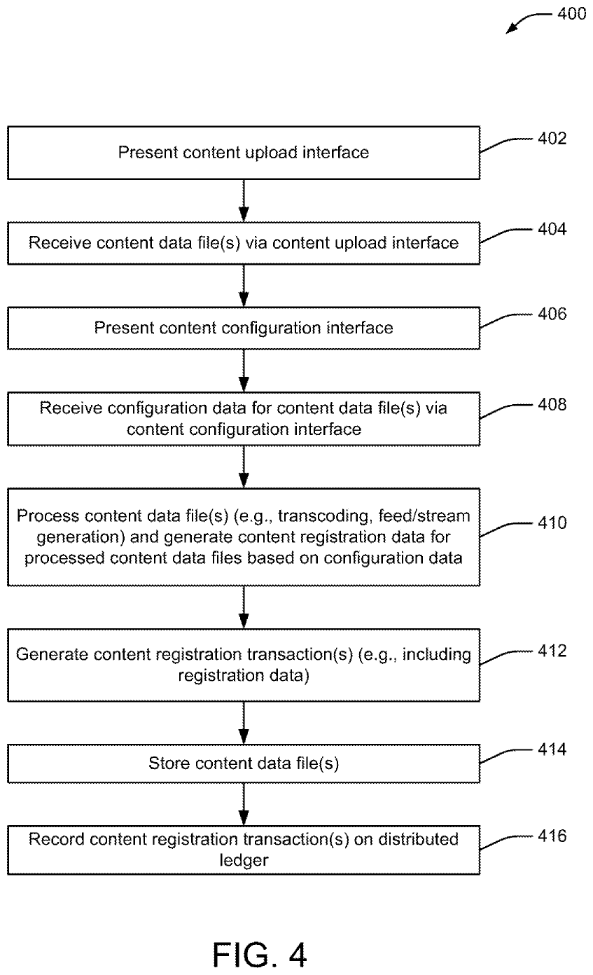

FIGS. 4-7 illustrate flowcharts including operational blocks of example processes in accordance with at least some example embodiments of the present disclosure. In some embodiments, the computer-implemented processes of FIGS. 4-7 are each embodied by computer program code stored on a non-transitory computer-readable medium of a computer program product configured for execution to perform the computer-implemented method. Alternatively or additionally, in some embodiments, the example processes of FIGS. 4-7 are performed by one or more specially configured computing devices, such as the specially configured apparatus 200 (e.g., via registration circuitry 212, consumption tracking circuitry 210, investment circuitry 214). In this regard, in some such embodiments, the apparatus 200 is specially configured by computer program instructions stored thereon, for example in the memory 204 and/or another component depicted and/or described herein, and/or otherwise accessible to the apparatus 200, for performing the operations as depicted and described with respect to the example processes of FIGS. 4-7. In some embodiments, the specially configured apparatus 200 includes and/or otherwise is in communication with one or more external apparatuses, systems, devices, and/or the like, to perform one or more of the operations as depicted and described. While the operational blocks of each of the example processes are depicted in each of FIGS. 4-7 in a particular order, this should not be understood as requiring that such operations be performed in the particular order shown or in sequential order, or that all illustrated operations be performed.

Moreover, in some embodiments, some or all of the computer-implemented processes of FIGS. 4-7 may each be partially or entirely embodied by computer program code or instructions recorded on a distributed ledger (e.g., distributed ledger 320) as part of one or more smart contracts. The smart contract(s) may comprise instructions (e.g., for performing the functionality of and/or corresponding to the functionality of the respective processes), and a distributed ledger system (e.g., distributed ledger system 120) may be configured to automatically execute or automatically cause execution (e.g., by peer nodes) of the instructions based on and/or in response to calls to and/or interactions with the recorded smart contracts.

FIG. 4 illustrates a flowchart including operational blocks of an example process 400 for receiving and registering content data files (e.g., of the content data 350) containing media content, in accordance with at least some example embodiments of the present disclosure.

The process 400 begins at operation 402, at which an apparatus (such as, but not limited to, the apparatus 200 or circuitry thereof as described above in connection with FIG. 2) presents a content upload interface. In various embodiments, the content upload interface presented at operation 402 may be and/or may comprise the content upload interface 304 as defined and described with respect to the example illustrated in FIG. 3, and presenting the content upload interface at operation 402 may comprise and/or correspond to some or all of the functionality for presenting the content upload interface 304 attributed to the registration and configuration process 302 as described with respect to FIG. 3.

At operation 404 of the process 400, an apparatus (such as, but not limited to, the apparatus 200 or circuitry thereof described above in connection with FIG. 2) receives one or more content data files via the content upload interface presented at operation 402. In various embodiments, the content data file(s) received at operation 404 may correspond to the content data file(s) and/or the content data 350 as defined and described with respect to FIG. 3, and receiving the content data file(s) at operation 404 may comprise and/or correspond to some or all of the functionality for receiving the content data file(s) and/or content data 350 attributed to the registration and configuration process 302 as described with respect to FIG. 3.

At operation 406 of the process 400, an apparatus (such as, but not limited to, the apparatus 200 or circuitry thereof described above in connection with FIG. 2) presents a content configuration interface. In various embodiments, the content configuration interface presented at operation 406 may be and/or may comprise the content configuration interface 306 as defined and described with respect to FIG. 3, and presenting the content configuration interface at operation 406 may comprise and/or correspond to some or all of the functionality for presenting the content configuration interface 306 attributed to the registration and configuration process 302 as described with respect to FIG. 3.

At operation 408 of the process 400, an apparatus (such as, but not limited to, the apparatus 200 or circuitry thereof described above in connection with FIG. 2) receives via the content configuration interface presented at operation 406 configuration data for and/or associated with the one or more content data files received at operation 404. In various embodiments, the configuration data received at operation 408 may correspond to the configuration data 352 as defined and described with respect to FIG. 3, and receiving the configuration data at operation 408 may comprise and/or correspond to some or all of the functionality for receiving the configuration data 352 attributed to the registration and configuration process 302 as described with respect to FIG. 3.

At operation 410 of the process 400, an apparatus (such as, but not limited to, the apparatus 200 or circuitry thereof described above in connection with FIG. 2) processes the one or more content data files received at operation 404 and generates content registration data for the processed content data file(s) based at least in part on the configuration data received at operation 408. In various embodiments, processing the content data file(s) at operation 410 may comprise transcoding the content data file(s) and/or generating one or more content streams and/or feeds for streaming and/or otherwise distributing the media content contained within the content data file(s). Additionally or alternatively, processing the content data file(s) at operation 410 may comprise some or all of the functionality for processing the content data 350 attributed to the registration and configuration process 302 as described with respect to FIG. 3. Additionally or alternatively, the registration data generated at operation 410 may correspond to the registration data 356 as defined and described with respect to FIG. 3, and generating the registration data at operation 410 may comprise and/or correspond to some or all of the functionality for generating the registration data 356 and/or registration transactions 354 attributed to the registration and configuration process 302 as described with respect to FIG. 3.

At operation 412 of the process 400, an apparatus (such as, but not limited to, the apparatus 200 or circuitry thereof described above in connection with FIG. 2) generates one or more content registration transactions based at least in part on (e.g., including) the registration data generated at operation 410. In various embodiments, the content registration transaction(s) generated at operation 412 may comprise and/or correspond to the registration transaction(s) 354 defined and described with respect to FIG. 3, and generating the content registration transaction(s) at operation 412 may comprise and/or correspond to some or all of the functionality for generating the registration transaction(s) 354 attributed to the registration and configuration process 302 as described with respect to FIG. 3.

At operation 414 of the process 400, an apparatus (such as, but not limited to, the apparatus 200 or circuitry thereof described above in connection with FIG. 2) stores the one or more content data files received at operation 404, for example, in a data repository (e.g., of the one or more data repositories 150) associated with the content consumption tracking system 140 and/or the content distribution system 110. In various embodiments, storing the content data file(s) at operation 414 may comprise and/or correspond to some or all of the functionality for storing the content data 350 and/or associated content data file(s) attributed to the registration and configuration process 302 as described with respect to FIG. 3.

At operation 416 of the process 400, an apparatus (such as, but not limited to, the apparatus 200 or circuitry thereof described above in connection with FIG. 2) records the one or more content registration transactions generated at operation 412 on a distributed ledger (e.g., via a distributed ledger system). In various embodiments, the distributed ledger referred to with respect to operation 416 may correspond to and/or comprise the distributed ledger 320 as defined and described with respect to FIG. 3, and recording the content registration transaction(s) at operation 416 may comprise and/or correspond to some or all of the functionality for recording the registration transaction(s) 354 on the distributed ledger 320 attributed to the registration and configuration process 302 as described with respect to FIG. 3.

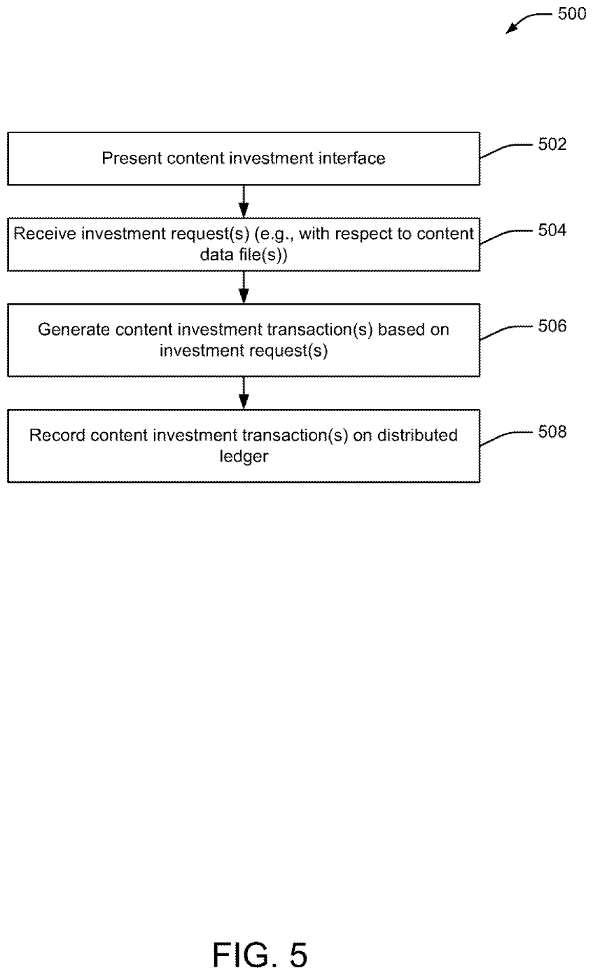

FIG. 5 illustrates a flowchart including operational blocks of an example process 500 for generating and recording content investment transactions, in accordance with at least some example embodiments of the present disclosure.

The process 500 begins at operation 502, at which an apparatus (such as, but not limited to, the apparatus 200 or circuitry thereof as described above in connection with FIG. 2) presents a content investment interface. In various embodiments, the content investment interface presented at operation 502 may correspond to and/or comprise the content investment interface 310 as defined and described with respect to FIG. 3, and presenting the content investment interface at operation 502 may comprise and/or correspond to some or all of the functionality for presenting the content investment interface 310 attributed to the investment process 308 as described with respect to FIG. 3.

At operation 504 of the process 500, an apparatus (such as, but not limited to, the apparatus 200 or circuitry thereof described above in connection with FIG. 2) receives one or more investment requests via the content investment interface presented at operation 502. In various embodiments, the investment request(s) received at operation 504 may comprise and/or correspond to the investment request(s) 358 as defined and described with respect to FIG. 3, and receiving the investment request(s) at operation 504 may comprise and/or correspond to some or all of the functionality for receiving the investment request(s) 358 attributed to the investment process 308 as described with respect to FIG. 3.

At operation 506 of the process 500, an apparatus (such as, but not limited to, the apparatus 200 or circuitry thereof described above in connection with FIG. 2) generates one or more content investment transactions based at least in part on the one or more investment requests received at operation 504. In various embodiments, the content investment transaction(s) generated at operation 506 may comprise and/or correspond to the investment transaction(s) 360 defined and described with respect to FIG. 3, and generating the content investment transaction(s) at operation 506 may comprise and/or correspond to some or all of the functionality for generating the investment transaction(s) 360 attributed to the investment process 308 as described with respect to FIG. 3.

At operation 508 of the process 500, an apparatus (such as, but not limited to, the apparatus 200 or circuitry thereof described above in connection with FIG. 2) records the one or more content investment transactions generated at operation 506 on a distributed ledger (e.g., via a distributed ledger system). In various embodiments, the distributed ledger referred to with respect to operation 508 may correspond to and/or comprise the distributed ledger 320 as defined and described with respect to FIG. 3, and recording the content investment transaction(s) at operation 508 may comprise and/or correspond to some or all of the functionality for recording the investment transaction(s) 360 on the distributed ledger 320 attributed to the investment process 308 as described with respect to FIG. 3.

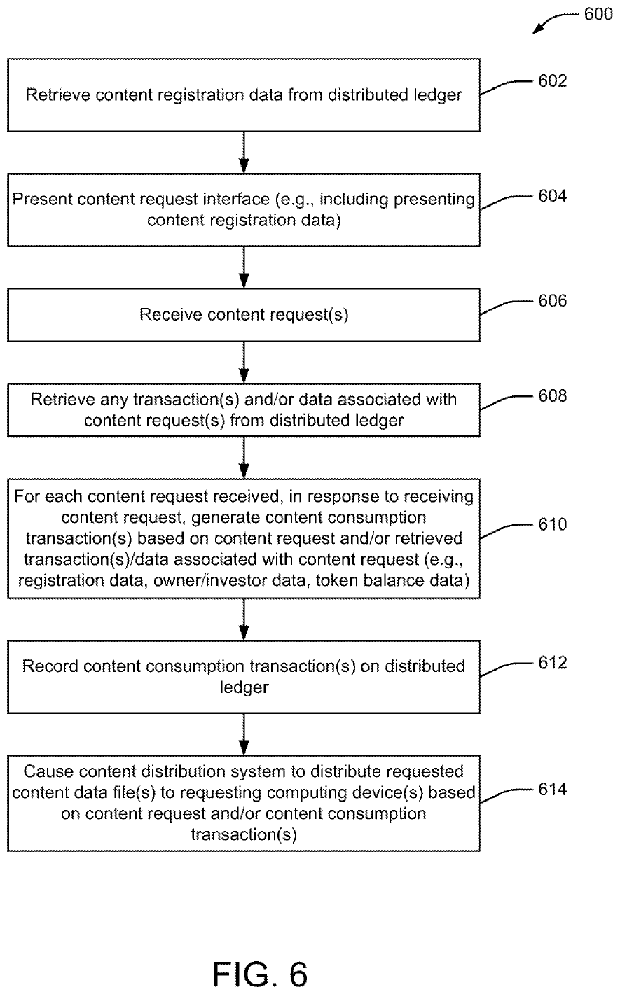

FIG. 6 illustrates a flowchart including operational blocks of an example process 600 for tracking media content consumption using a distributed ledger, in accordance with at least some example embodiments of the present disclosure.

The process 600 begins at operation 602, at which an apparatus (such as, but not limited to, the apparatus 200 or circuitry thereof as described above in connection with FIG. 2) retrieves content registration data from a distributed ledger (e.g., via a distributed ledger system). The content registration data retrieved at operation 602 may correspond to and/or comprise the registration data 356 as defined and described with respect to FIG. 3, and retrieving the content registration data at operation 602 may comprise and/or correspond to some or all of the functionality for retrieving registration data 356 attributed to the tracking process 312 as described with respect to FIG. 3. Additionally or alternatively, the distributed ledger referred to with respect to operation 602 may correspond to and/or comprise the distributed ledger 320 as defined and described with respect to FIG. 3. Additionally or alternatively, the content registration data retrieved at operation 602 may correspond to and/or comprise the content registration data generated at operation 410 of the process 400 and/or the content registration data included in the content registration transaction(s) generated at operation 412 of the process 400.

At operation 604 of the process 600, an apparatus (such as, but not limited to, the apparatus 200 or circuitry thereof described above in connection with FIG. 2) presents a content request interface. In some embodiments, presenting the content request interface at operation 604 may comprise presenting some or all of the content registration data retrieved from the distributed ledger at operation 602, for example, as part of the content request interface, including any metadata descriptive of each of the discrete units of media content to which the content registration data is associated (e.g., title, creator(s), duration, type, format, description, episode number, publication date, category, language) along with usage criteria and/or pricing data associated with licensing, use, distribution, and/or consumption of the media content. In various embodiments, the content request interface presented at operation 604 may correspond to and/or comprise the content request interface 314 as defined and described with respect to FIG. 3, and presenting the content request interface at operation 604 may comprise and/or correspond to some or all of the functionality for presenting the content request interface 314 attributed to the tracking process 312 as described with respect to FIG. 3.

At operation 606 of the process 600, an apparatus (such as, but not limited to, the apparatus 200 or circuitry thereof described above in connection with FIG. 2) receives one or more content requests via the content request interface presented at operation 604. In some embodiments, the content request(s) received at operation 606, in conjunction with the content request interface, may be generated by, transmitted by, and/or received from one or more user devices 160, such as consumer computing devices 160c configured to present media content (e.g., identified in the content request(s)) to media consumers. In some embodiments, the content request(s) received at operation 606, in conjunction with the content request interface, may be generated by, transmitted by, and/or received from (e.g., servers of) one or more content distribution platforms 330 configured to stream media content (e.g., identified in the content request(s)) to the consumer computing devices 160c. In various embodiments, the content request(s) received at operation 606 may comprise and/or correspond to the content request(s) 364 as defined and described with respect to FIG. 3, and receiving the content request(s) at operation 606 may comprise and/or correspond to some or all of the functionality for receiving the content request(s) 364 attributed to the tracking process 312 as described with respect to FIG. 3.

At operation 608 of the process 600, an apparatus (such as, but not limited to, the apparatus 200 or circuitry thereof described above in connection with FIG. 2) retrieves from the distributed ledger any transaction(s) and/or data associated with and/or related to the content request(s) received at operation 606. In some embodiments, for a given content request of the content request(s) received at operation 606, the apparatus may retrieve registration data (e.g., provided within registration transactions recorded on the distributed ledger) associated with requested content identified in the given content request (e.g., via a requested content identifier). The apparatus may retrieve investor data (e.g., provided within investment transactions recorded on the distributed ledger) associated with the requested content identified in the given content request. The apparatus may retrieve token balance(s) (e.g., from transactions recorded on the distributed ledger representing token transfers) associated with any requesting entities (e.g., media consumers, content distribution platforms) associated with the given content request (e.g., identified in the given content request, associated with device(s) from which the given content request originated). In various embodiments, the transaction(s) and/or data retrieved at operation 608 may correspond to and/or comprise the registration data 356, the investor data 366, and/or the token balance(s) 368 defined and described with respect to FIG. 3, and retrieving the transaction(s) and/or data at operation 608 may comprise and/or correspond to some or all of the functionality for retrieving such data attributed to the tracking process 312 as described with respect to FIG. 3

At operation 610 of the process 600, for each content request of the one or more content requests received at operation 606, in response to receiving the content request, an apparatus (such as, but not limited to, the apparatus 200 or circuitry thereof described above in connection with FIG. 2) generates one or more content consumption transactions based at least in part on the content request and/or the transaction(s) and/or data retrieved at operation 608 with respect to the content request. The consumption transaction(s) generated at operation 610 may comprise and/or correspond to the consumption transaction(s) 370 defined and described with respect to FIG. 3, and generating the consumption transaction(s) at operation 610 may comprise and/or correspond to any or all of the functionality attributed to the tracking process 312 for generating the consumption transaction(s) 370.

For example, generating the content consumption transaction(s) at operation 610 may comprise generating a content consumption transaction representing a transfer of token value to (e.g., an account associated with) an owner and/or creator of the media content identified in the content request. The owner and/or creator may be represented by and/or determined using an owner identifier associated with the requested content data and/or content data file(s) identified in the content request (e.g., via a requested content identifier indicated in the content request), for example, as indicated in metadata for the requested content data file(s) and/or the retrieved registration data. The token value may represent an amount of a medium of exchange native to a content consumption tracking system (with which the apparatus is associated) and implemented via the distributed ledger, including, for example, a (e.g., fungible) token.

In another example, generating the content consumption transaction(s) at operation 610 may comprise generating a content consumption transaction representing a transfer of token value from (e.g., an account associated with) a requesting entity associated with the content request, such as a media consumer to which the requested content will be and/or has been presented and/or a content distribution entity associated with a content distribution platform for providing the requested content to a media consumer.

In another example, generating the content consumption transaction(s) at operation 610 may comprise generating a content consumption transaction representing a transfer of token value to (e.g., an account associated with) a media consumer to which the requested content will be and/or has been presented. This transfer of token value may be from (e.g., an account associated with) a content distribution entity associated with a content distribution platform for providing the requested content to a media consumer, for example.

In yet another example, generating the content consumption transaction(s) at operation 610 may comprise generating at least one content consumption transaction including consumption tracking data describing, characterizing, and/or quantifying one or more instances of presenting the content contained within the requested content data file to one or more consuming users. In various embodiments, the tracking data may comprise and/or correspond to the tracking data 374 as defined and described with respect to FIG. 3.

At operation 612 of the process 600, for each content request of the one or more content requests received at operation 606, in response to receiving the content request, an apparatus (such as, but not limited to, the apparatus 200 or circuitry thereof described above in connection with FIG. 2) records the one or more content consumption transactions generated for the content request at operation 610 on a distributed ledger (e.g., via a distributed ledger system). In various embodiments, the distributed ledger referred to with respect to operation 614 may correspond to and/or comprise the distributed ledger 320 as defined and described with respect to FIG. 3, and recording the content consumption transaction(s) at operation 614 may comprise and/or correspond to some or all of the functionality for recording the consumption transaction(s) 370 on the distributed ledger 320 attributed to the tracking process 312 as described with respect to FIG. 3.

At operation 614 of the process 600, for each content request of the one or more content requests received at operation 606, in response to receiving the content request, an apparatus (such as, but not limited to, the apparatus 200 or circuitry thereof described above in connection with FIG. 2) causes a content distribution system (e.g., content distribution system 110 as defined and described with respect to FIG. 1) to distribute the requested content data file(s) indicated in the content request to a requesting computing device associated with the content request. The requested content data file(s) distributed at operation 614 may be represented by a content identifier included in the content request, for example. The requesting computing device may be of the one or more user devices 160, including, for example the consumer computing device 160c described with respect to FIG. 3. The requesting computing device may be a server device or other computing device of the content distribution platform 330 defined and described with respect to FIG. 3.

Operation 614 may comprise causing the content distribution system to distribute the requested content data file(s) based at least in part on the content request and/or based at least in part on the one or more content consumption transactions generated at operation 610. For example, the apparatus may determine whether a requesting party (e.g., media consumer associated with a consumer computing device 160c, media distribution entity associated with media distribution platform 330) has a sufficiently high token balance such that a token value representing an amount corresponding to a price associated with the requested media content (e.g., in the pricing data provided in the registration data) can be successfully transferred to the owner, creator, and/or investor(s) associated with the requested media content and to cause the content distribution system 110 to distribute the requested content 376 only in response to determining that the token balance is sufficiently high and/or that the transfer has been completed. In another example, the apparatus may communicate technical details (e.g., identifiers and/or addresses associated with content streams and/or feeds corresponding to the requested media content) included in the registration data to the content distribution system and/or to communicate with the content distribution system based at least in part on the technical details. In another example, the apparatus may determine whether or not to allow distribution of the requested content based at least in part on usage criteria indicated in the registration data corresponding to the requested content.

Additionally or alternatively, causing the content distribution system to distribute the requested content data file(s) at operation 614 may comprise and/or correspond to some or all of the functionality attributed to the tracking process 312 for causing the requested content data file(s) to be distributed as described with respect to FIG. 3.

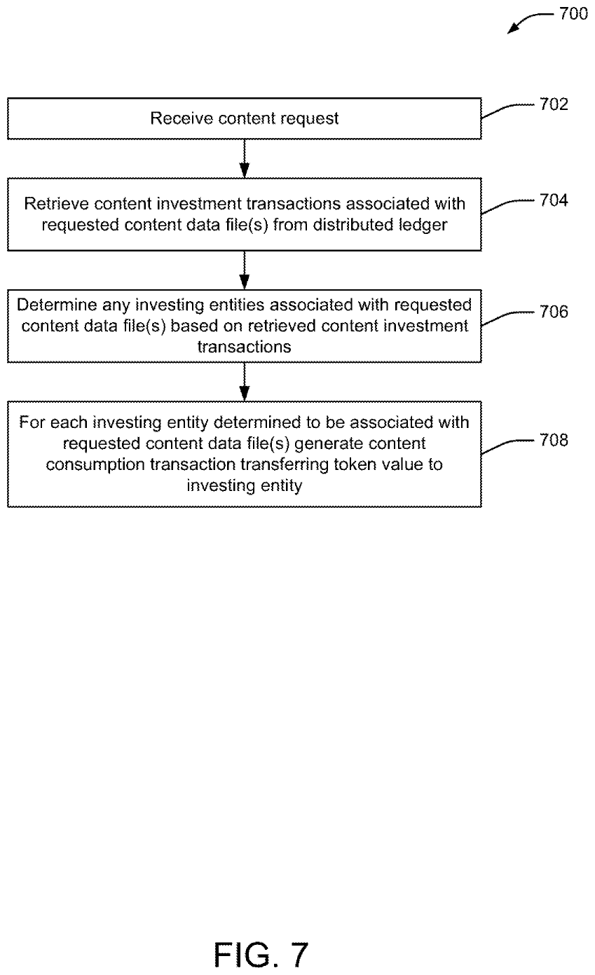

FIG. 7 illustrates a flowchart including operational blocks of an example process 700 for generating content consumption transactions transferring token value to investing entities associated with requested media content, in accordance with at least some example embodiments of the present disclosure.

The process 700 begins at operation 702, at which an apparatus (such as, but not limited to, the apparatus 200 or circuitry thereof as described above in connection with FIG. 2) receives a content request (e.g., via a content request interface). The content request received at operation 702 may be one of the one or more content requests received at operation 606 as described with respect to FIG. 6, in one example, and receiving the content request at operation 702 may be part of the functionality of operation 606 as described with respect to FIG. 6.

At operation 704 of the process 700, an apparatus (such as, but not limited to, the apparatus 200 or circuitry thereof described above in connection with FIG. 2) retrieves from a distributed ledger (e.g., via a distributed ledger system) one or more content investment transactions associated with requested content data file(s) indicated or identified in the content request received at operation 702. In one example, the content investment transaction(s) retrieved at operation 704 may be part of the transaction(s) and/or data associated with the content requests retrieved at operation 608 as described with respect to FIG. 6, and retrieving the content investment transaction(s) at operation 704 may be part of the functionality of operation 608 as described with respect to FIG. 6. Additionally or alternatively, the content investment transaction(s) retrieved at operation 704 may comprise and/or correspond to the investment transaction(s) 360 and/or the investor data 366 defined and described with respect to FIG. 3, and retrieving the content investment transaction(s) at operation 704 may comprise and/or correspond to some or all of the functionality attributed to the tracking process 312 for retrieving the investor data 366 as described with respect to FIG. 3. Moreover, the distributed ledger referred to with respect to operation 704 may correspond to and/or comprise the distributed ledger 320 as defined and described with respect to FIG. 3.

At operation 706 of the process 700, an apparatus (such as, but not limited to, the apparatus 200 or circuitry thereof described above in connection with FIG. 2) determines any investing entities associated with the requested content data file(s) indicated or identified in the content request received at operation 702 (e.g., represented by a content identifier included in content request and representing the requested content) based at least in part on the content investment transaction(s) retrieved at operation 704. For example, the apparatus may determine the investing entities to be any current owners of NFTs representing investments with respect to the requested content as indicated in the retrieved content investment transaction(s).

At operation 708 of the process 700, for each investing entity determined to be associated with the requested content data file(s) at operation 706, an apparatus (such as, but not limited to, the apparatus 200 or circuitry thereof described above in connection with FIG. 2) generates a content consumption transaction transferring token value to the investing entity (e.g., in connection with consumption of the requested media content). For example, the apparatus may designate each associated investing entity determined at operation 706 as a recipient of a token transfer (e.g., to be included in the content consumption transaction generated at operation 708). In one example, the content consumption transaction generated at operation 708 may be one of the one or more content consumption transactions generated at operation 610 as described with respect to FIG. 6, and generating the content consumption transaction at operation 708 may be part of the functionality of operation 610 as described with respect to FIG. 6.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. A computer-implemented method comprising:
receiving, via a content request interface of a content consumption tracking system, one or more content requests with respect to one or more content data files, wherein each content data file of the one or more content data files is associated with an owner identifier representing an owner of media content contained within the content data file, and each content request of the one or more content requests comprises a requested content identifier representing a requested content data file of the one or more content data files; and
in response to receiving each content request of the one or more content requests, performing operations comprising:
generating one or more content consumption transactions based at least in part on the content request, wherein at least one content consumption transaction of the one or more content consumption transactions represents a transfer of token value to the owner represented by the owner identifier associated with the requested content data file represented by the requested content identifier of the content request, and the token value represents an amount of a medium of exchange native to the content consumption tracking system and implemented via a distributed ledger associated with the content consumption tracking system;
recording the one or more content consumption transactions to the distributed ledger; and
causing a content distribution system associated with the content consumption tracking system to distribute the requested content data file represented by the requested content identifier of the content request to a requesting computing device associated with the content request based at least in part on the content request and the one or more content consumption transactions.

2. The method of claim 1, wherein generating the one or more content consumption transactions for a content request of the one or more content requests comprises generating a content consumption transaction, of the one or more content consumption transactions, representing a transfer of token value from a requesting entity associated with the content request.

3. The method of claim 1, wherein generating the one or more content consumption transactions for a content request of the one or more content requests comprises generating a content consumption transaction, of the one or more content consumption transactions, representing a transfer of token value to a consuming user associated with a content consumer computing device that presents the content contained within the requested content data file to the consuming user.

4. The method of claim 1, wherein generating the one or more content consumption transactions for a content request of the one or more content requests comprises generating at least one content consumption transaction, of the one or more content consumption transactions, including consumption tracking data describing, characterizing, and/or quantifying one or more instances of presenting the content contained within the requested content data file to one or more consuming users.

5. The method of claim 1, further comprising:
generating one or more content investment transactions with respect to one or more non-fungible tokens (NFTs), wherein each NFT of the one or more NFTs is associated with a content data file of the one or more content data files, and, for each NFT of the one or more NFTs, at least one content investment transaction associated with the NFT represents a transfer of token value from an investing entity to the owner represented by the owner identifier associated with the content data file associated with the NFT in exchange for a transfer of the NFT to the investing entity; and
recording the one or more content investment transactions to the distributed ledger.

6. The method of claim 5, wherein generating the one or more content consumption transactions for a content request of the one or more content requests comprises:
determining any investing entities associated with the requested content data file represented by the requested content identifier of the content request based at least in part on the one or more content investment transactions recorded on the distributed ledger; and
for each investing entity determined to be associated with the requested content data file, generating a content consumption transaction, of the one or more content consumption transactions, representing a transfer of token value to the investing entity.

7. The method of claim 1, wherein generating the one or more content consumption transactions for a content request of the one or more content requests comprises generating a content consumption transaction, of the one or more content consumption transactions, representing a transfer of token value from a consuming user associated with a content consumer computing device that presents the content contained within the requested content data file to the consuming user, and, in exchange for the transfer of the token value from the consuming user, causing a consumer computing device to present the content contained within the requested content data file without presenting advertising content in conjunction with presentation of the content contained within the requested content data file.

8. The method of claim 1, further comprising:
receiving configuration data associated with each content data file of the one or more content data files, wherein the configuration data for each content data file of the one or more content data files is received from a computing device associated with the owner represented by the owner identifier associated with the content data file via a content configuration interface of the content consumption tracking system;
generating a content registration transaction associated with each content data file of the one or more content data files based at least in part on the configuration data associated with the content data file; and
recording the content registration transaction associated with each content data file of the one or more content data files on the distributed ledger,
wherein the one or more content consumption transactions for each content request of the one or more content requests are generated based at least in part on the content registration transaction, of the one or more content registration transactions recorded on the distributed ledger, associated with the requested content data file represented by the requested content identifier of the content request.

9. The method of claim 8, wherein the content registration transaction associated with each content data file of the one or more content data files comprises user-specified usage criteria associated with the content data file.

10. The method of claim 8, wherein the content registration transaction associated with each content data file of the one or more content data files comprises user-specified pricing data associated with the content data file.

11. An apparatus comprising at least one processor and at least one non-transitory memory comprising program code stored thereon, wherein the at least one non-transitory memory and the program code are configured to, with the at least one processor, cause the apparatus to at least:
receive, via a content request interface of a content consumption tracking system, one or more content requests with respect to one or more content data files, wherein each content data file of the one or more content data files is associated with an owner identifier representing an owner of media content contained within the content data file, and each content request of the one or more content requests comprises a requested content identifier representing a requested content data file of the one or more content data files; and
in response to receiving each content request of the one or more content requests, perform operations comprising:
generating one or more content consumption transactions based at least in part on the content request, wherein at least one content consumption transaction of the one or more content consumption transactions represents a transfer of token value to the owner represented by the owner identifier associated with the requested content data file represented by the requested content identifier of the content request, and the token value represents an amount of a medium of exchange native to the content consumption tracking system and implemented via a distributed ledger associated with the content consumption tracking system;
recording the one or more content consumption transactions to the distributed ledger; and
causing a content distribution system associated with the content consumption tracking system to distribute the requested content data file represented by the requested content identifier of the content request to a requesting computing device associated with the content request based at least in part on the content request and the one or more content consumption transactions.

12. The apparatus of claim 11, wherein generating the one or more content consumption transactions for a content request of the one or more content requests comprises generating a content consumption transaction, of the one or more content consumption transactions, representing a transfer of token value from a requesting entity associated with the content request.

13. The apparatus of claim 11, wherein generating the one or more content consumption transactions for a content request of the one or more content requests comprises generating a content consumption transaction, of the one or more content consumption transactions, representing a transfer of token value to a consuming user associated with a content consumer computing device that presents the content contained within the requested content data file to the consuming user.

14. The apparatus of claim 11, wherein generating the one or more content consumption transactions for a content request of the one or more content requests comprises generating at least one content consumption transaction, of the one or more content consumption transactions, including consumption tracking data describing, characterizing, and/or quantifying one or more instances of presenting the content contained within the requested content data file to one or more consuming users.

15. The apparatus of claim 11, wherein the at least one non-transitory memory and the program code are configured to, with the at least one processor, cause the apparatus to at least:
generate one or more content investment transactions with respect to one or more non-fungible tokens (NFTs), wherein each NFT of the one or more NFTs is associated with a content data file of the one or more content data files, and, for each NFT of the one or more NFTs, at least one content investment transaction associated with the NFT represents a transfer of token value from an investing entity to the owner represented by the owner identifier associated with the content data file associated with the NFT in exchange for a transfer of the NFT to the investing entity; and
record the one or more content investment transactions to the distributed ledger.

16. The apparatus of claim 15, wherein generating the one or more content consumption transactions for a content request of the one or more content requests comprises:
determining any investing entities associated with the requested content data file represented by the requested content identifier of the content request based at least in part on the one or more content investment transactions recorded on the distributed ledger; and
for each investing entity determined to be associated with the requested content data file, generating a content consumption transaction, of the one or more content consumption transactions, representing a transfer of token value to the investing entity.

17. The apparatus of claim 11, wherein generating the one or more content consumption transactions for a content request of the one or more content requests comprises generating a content consumption transaction, of the one or more content consumption transactions, representing a transfer of token value from a consuming user associated with a content consumer computing device that presents the content contained within the requested content data file to the consuming user, and, in exchange for the transfer of the token value from the consuming user, causing a consumer computing device to present the content contained within the requested content data file without presenting advertising content in conjunction with presentation of the content contained within the requested content data file.

18. The apparatus of claim 11, wherein the at least one non-transitory memory and the program code are configured to, with the at least one processor, cause the apparatus to at least:
receive configuration data associated with each content data file of the one or more content data files, wherein the configuration data for each content data file of the one or more content data files is received from a computing device associated with the owner represented by the owner identifier associated with the content data file via a content configuration interface of the content consumption tracking system;
generate a content registration transaction associated with each content data file of the one or more content data files based at least in part on the configuration data associated with the content data file; and
record the content registration transaction associated with each content data file of the one or more content data files on the distributed ledger,
wherein the one or more content consumption transactions for each content request of the one or more content requests are generated based at least in part on the content registration transaction, of the one or more content registration transactions recorded on the distributed ledger, associated with the requested content data file represented by the requested content identifier of the content request.

19. The apparatus of claim 18, wherein the content registration transaction associated with each content data file of the one or more content data files comprises user-specified usage criteria associated with the content data file.

20. The apparatus of claim 18, wherein the content registration transaction associated with each content data file of the one or more content data files comprises user-specified pricing data associated with the content data file.

21. A computer program product comprising at least one non-transitory computer-readable storage medium having computer-readable program code portions stored therein, the computer-readable program code portions comprising an executable portion configured to:
receive, via a content request interface of a content consumption tracking system, one or more content requests with respect to one or more content data files, wherein each content data file of the one or more content data files is associated with an owner identifier representing an owner of media content contained within the content data file, and each content request of the one or more content requests comprises a requested content identifier representing a requested content data file of the one or more content data files; and
in response to receiving each content request of the one or more content requests, perform operations comprising:
generating one or more content consumption transactions based at least in part on the content request, wherein at least one content consumption transaction of the one or more content consumption transactions represents a transfer of token value to the owner represented by the owner identifier associated with the requested content data file represented by the requested content identifier of the content request, and the token value represents an amount of a medium of exchange native to the content consumption tracking system and implemented via a distributed ledger associated with the content consumption tracking system;
recording the one or more content consumption transactions to the distributed ledger; and
causing a content distribution system associated with the content consumption tracking system to distribute the requested content data file represented by the requested content identifier of the content request to a requesting computing device associated with the content request based at least in part on the content request and the one or more content consumption transactions.
